(19) United States
(12) Patent Application Publication
(10) Pub. No.: US 2010/0194783 A1
(43) Pub. Date: Aug. 5, 2010

(54) MAP DISPLAY DEVICE

(75) Inventors: Tomokazu Kanamaru, Osaka (JP); Shigeaki Watanabe, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/677,394

(22) PCT Filed: Sep. 25, 2008
(86) PCT No.: PCT/JP2008/002658

§ 371 Date: Mar. 10, 2010

(30) Foreign Application Priority Data
Sep. 26, 2007 (JP) 2007-249086

(51) Int. Cl. G09G 5/00

(52) U.S. Cl. 345/660

(57) ABSTRACT

In a display device of the present invention, a map, one or more positions on the map, and one or more information pieces associated with the positions are stored; the stored map is displayed in on a display; one or more prescribed-sized display area portions of a display area, on which the map is displayed, is selected; and an information piece associated with a position on the map being displayed in the prescribed-sized display area portion is displayed on the map.

### TECHNICAL FIELD

The present invention relates to a display device for displaying a map and information associated with a position on the map, and in particular to a method to specify the position on the map and to display the associated information.

### BACKGROUND ART

In recent years, consumer electronics devices (hereinafter, referred to as “CE device”) with a network communication function have come to be widespread. Such CE devices include, for example, a display device, such as a TV, and a device for playing back and recording data on an optical disc, such as a DVD and a Blu-ray disc.

Many CE devices have come to be connectable to a network because various services have been offered via the network as a result of the significant changes in the environment, where, for example, the density of the network has been increased due to the increase in the number of internet users, and where the network content has been structured using XML (eXtensible Markup Language), etc. That is to say, a user can enjoy various services not only with information devices such as a personal computer, but also with conventional CE devices.

These services include a map display service. With this service, when a position on a map is specified, information associated with information of the position (hereinafter, referred to as “meta information”), such as an area name of the position, names of buildings or commercial facilities located at the position, etc. is displayed.

Here, with the use of FIG. 23, a brief description is given of a typical example of a conventional map display service. This service is realized on a browser application, and is implemented on a device such as a PC connected to a network and having a browser application.

For example, when a user enters a plurality of search keywords such as “Osaka” and “book” in a text box 102 on a display screen 101, a map including Osaka and its surroundings is displayed on a map screen 103, and positions associated with meta information on “book”, namely “A” (104), “B”, etc., are displayed on the map.

Furthermore, with the conventional service, meta information can be displayed in conjunction with search result ranking based on a keyword.

An information screen 105 in FIG. 23 shows a specific example of the service for displaying meta information.

On the information screen 105, meta information pieces associated with positions on the map are displayed in the order of the search result ranking. Examples of such meta information pieces include an ad image 106 and hyperlinks, namely URLs (Uniform Resource Locator) 107, leading to the sites of shops and facilities located at the position. This ranking is determined by one offering the service to accumulate meta information using its own evaluation algorithm.

The example of the map display service described using FIG. 23 is a service designed to be implemented with an information device such as a PC. However, a CE device connectable to a network can also provide a similar map display service.

However, unlike an information device such as a PC, a CE device generally does not have a pointing device such as a mouse, and only has a display screen with a small number of pixels.

That is to say, a TV, a recording & playback device, etc. only have a so-called remote controller. Unlike with a mouse, it is difficult for a user to directly specify a specific area or position on a map displayed on the screen with such a remote controller. In addition, since a display screen thereof has a small number of pixels, it is unrealistic, in view of the visibility, to display a map screen and an information screen side by side.

Here, one technique used for a TV receiver, which is one of CE devices, is known. That technique is used for referring to map information with the use of a remote controller thereof (see Patent Literature 1).

With this technique, when icons on the map screen are sequentially selected, which is a method to select conventional-type menus in hierarchy, meta information is displayed on the screen.

With this technique, a user can display meta information associated with a position on the displayed map with the use of a remote controller.

### [Citation List]

### [Patent Literature 1]

International Publication No. WO 01/030075

### SUMMARY OF INVENTION

### Technical Problem

However, with this technique, although a user can display meta information with the use of a remote controller, he has to select icons one after another, which is not user-friendly. Furthermore, according to this technique, meta information is displayed in a different area from a map. Therefore, when meta information is displayed on a screen having a small number of pixels, this technique presents a problem in view of the visibility.

In view of the above problems, the object of the present invention is to provide a map display device for displaying a map from which a user can easily specify a position with a simple interface such as a remote controller, and for displaying meta information on a screen by a display method which presents no problem with the visibility of the screen even if the screen only has a small number of pixels.

### Solution to Problem

To achieve the above object, a map display device pertaining to the present invention includes a storage unit that stores therein a map one or more positions on the map, and one or more information pieces associated with the positions; a map display unit that displays the map on a display; a selection unit operable that selects a prescribed-sized display area portion of in the display area, in which the map is displayed, in accordance with a user operation; and an information display unit that displays, on the map, an information piece associated with a position on the map being displayed in the prescribed-sized display area portion.

### ADVANTAGEOUS EFFECTS OF INVENTION

According to the map display device having the above configuration, a user can select a predetermined-sized display area portion from a display area on which a map is displayed, and can display an information piece associated with a position in the selected portion. Since the associated information piece can be superimposed on the map, the associated information piece can be displayed on a screen in a user-friendly manner even if the screen is small.

The display device of the present invention may further include a focus unit that focuses on at least one of a plurality of display area portions into which the display area has been divided, in accordance with a user operation, wherein the focus unit may focus on at least one of the display area portions that is adjacent to a display area portion currently in focus in a direction specified by a user operation, and the selection unit may select the display area portion in focus, in accordance with a user operation.

With this configuration, since the display area on which the map is displayed is divided into display area portions, a user can specify a position on the map by specifying a display area portion. For example, with direction buttons, which indicates a right, left, up or down direction, included in a remote controller, a user can easily change and select the specified portion. In other words, this configuration allows a user to easily select a display area portion with a simple interface such as a remote controller included in a CE device.

That is to say, a service of displaying and referring to map information and its associated information can be implemented on an interface with limited functions. Even an interface lacking functional versatility, such as a conventional remote controller included in a CE device, can realize the above service with its high usability being kept.

The information display unit may display, on the map being displayed in the selected display area portion, an information piece associated with a position on the map being displayed in the selected display area portion.

With this configuration, the information piece associated with the position is displayed on the selected display area portion. Accordingly, the associated information piece can be presented to a user in the selected display area portion; hence it is unnecessary to provide a different display area from the display area on which the map is displayed.

A plurality of information pieces may be associated with one or more positions included in a display area portion selected by the selection unit. The display device may further include a switch instruction obtaining unit operable to externally obtain an instruction to switch among the plurality of information pieces, and if the switch instruction obtaining unit obtains the switch instruction while one of the information pieces is being displayed, the information display unit may switch the display to another one of the information pieces.

With this configuration, if the switching instruction is given, such as pressing on a specific button of a remote controller, the associated information pieces to be displayed are switched from one after another. Accordingly, a user can refer to a plurality of meta information pieces with a simple interface, without executing a highly complicated operation, such as pointing with a pointing device or scrolling a list for display, as conventionally performed.

Furthermore, even if associated information pieces are densely located in a specific display area portion on the map, this configuration allows a user to specify a display area portion on the map from which the user desires to obtain associated information pieces, and to sequentially display the desired associated information pieces. Thus, a user can efficiently refer to the associated information pieces with a simple operation.

Furthermore, when a user causes the device to display associated information pieces in a selected portion on the map, and gives an instruction to switch among the associated information pieces, a user can directly search for the information pieces associated with the map information. This configuration is advantageous, for it somewhat entertains the user.

The display area portions focused on by the focus unit may be polygonal portions, into which the display area has been divided based on the map displayed by the map display unit.

Each polygonal portion may be surrounded by a road on the map.

The display area portions focused on by the focus unit are rectangular portions, into which the display area has been divided in a grid pattern.

The display device of the present invention may further include a route indication unit operable to indicate a route in the displayed map, and the prescribed-sized display area portion may be composed of a road shown by the indicated route and a portion with a prescribed width along the road.

With this configuration, because the shape of each display area portion is different, a user can select a display area portion according to intended use. For example, in a map of a car navigation system, a user can select an area along a road on the map.

Each associated information piece displayed by the information display unit may be an advertisement for a shop located at the position.

This configuration enables a user to easily select a display area portion on a map, and to display an advertisement for a shop in the selected portion.

The selection unit may select a plurality of display area portions included in the display area, and the information display unit may display information pieces associated with positions in all the plurality of selected display area portions.

This configuration enables a user to select a plurality of display area portions on a map and to display the associated information pieces in a large region in the display area, desired by a user.

### BRIEF DESCRIPTION OF DRAWINGS

FIG. 1 is a functional block diagram showing the configuration of a TV 100 in accordance with Embodiment 1 of the present invention;

FIG. 2 shows a remote controller and a display;

FIG. 3 shows a screen on which a map is displayed;

FIG. 4 shows a case where one display area portion of the screen on which a map is displayed is in focus;

FIG. 5 shows the transitions of focus on display area portions in a screen 201 and display of meta information;

FIG. 6 shows transitions of display of meta information on the screen 201;

FIG. 7 shows the structure and an example of contents included in area division information 1210;

FIG. 8 shows the structure and an example of contents included in a meta information piece;

FIG. 9 is a flow chart showing a display process of a map;

FIG. 10 is a flow chart showing a display process of meta information;

FIG. 11 shows a case where meta information and random information are displayed;

FIG. 12 is a flow chart showing the display process of random information in accordance with Modification;

FIG. 13 shows a case where a block in an urban area is displayed as a display area portion;

FIG. 14 shows a case where a surrounding area of a route is displayed as a display area portion;

FIG. 15 is a functional block diagram showing the configuration of a TV 100 in accordance with Embodiment 2 of the present invention;

FIG. 16 shows the structure and an example of contents included in area division information 1220;

FIG. 17 shows an example where display area portions are superimposed with each other;

FIG. 18 shows a case where the display area portion is circular;

FIG. 19 shows a case where a plurality of display area portions are in focus;

FIG. 20 shows a case where a meta information piece is superimposed on an adjacent display area portion for display;

FIG. 21 shows a case where a meta information piece is displayed in a balloon;

FIG. 22 shows a case where a meta information piece is displayed on a different display; and

FIG. 23 shows an example of a conventional map display service.

### REFERENCE SIGNS LIST

100, 500 TV
200 display
300 remote controller
1000 display control unit
1100 map display unit
1200, 5200 area division unit
1300, 5300 in-focus portion display unit
1400 operation detection unit
1500 meta information display unit
1600 video display control unit
2000 map information storage unit
2100, 5100 area information storage unit
2200 meta information storage unit

### DESCRIPTION OF EMBODIMENTS

### Embodiment 1

### [Overview]

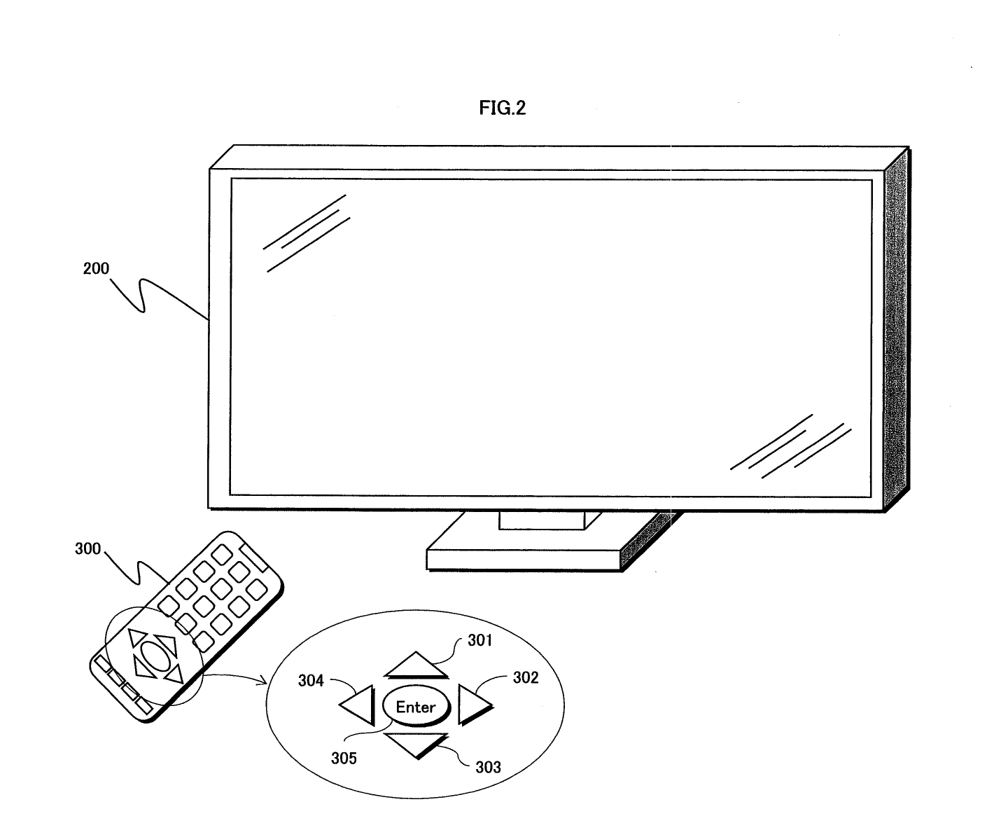

A remote controller, which is an interface of a conventional CE device, is usually provided with only buttons each specialized for executing a certain function, such as buttons for selecting channels and buttons for entering right, left, up and down directions, etc. Thus, a remote controller lacks versatility in terms of the functionality. More specifically, as shown in FIG. 2, a remote controller 300 has channel buttons such as “1” and “2”, direction buttons (301, 302, 303, 304), and an enter button 305.

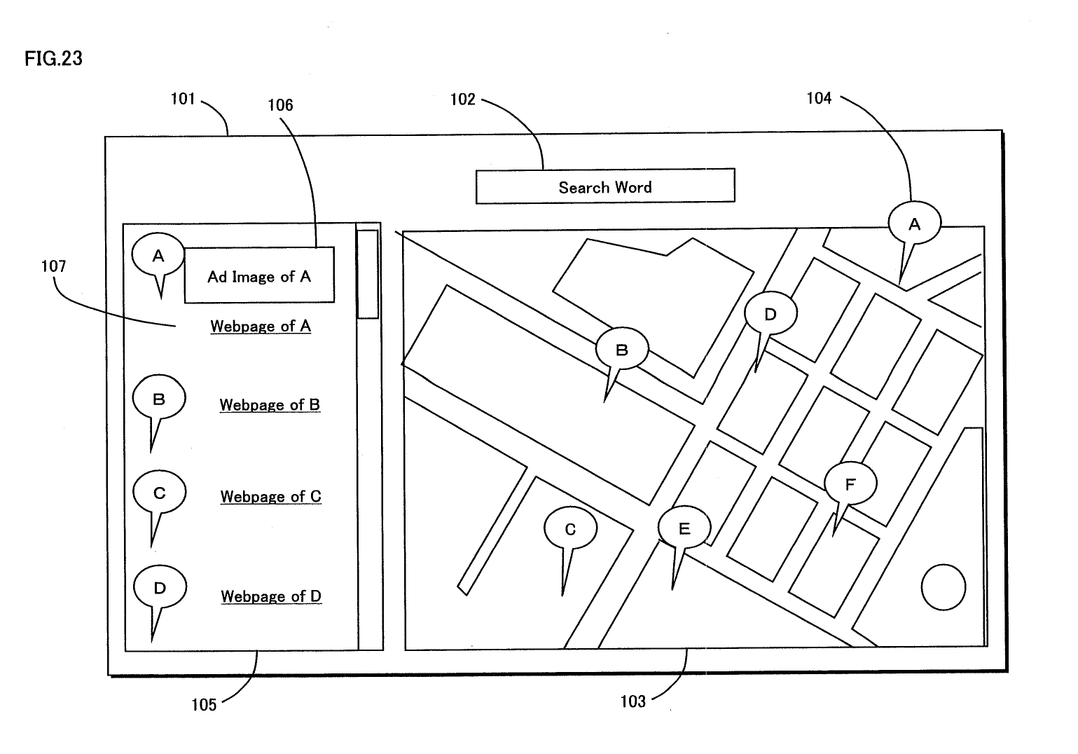

Accordingly, in the map display service as described in FIG. 23, it is difficult for a user to directly point a specific portion or position on a map with a remote controller. In an information device assumed to have a pointing device such as a mouse, a user can naturally and directly designate a desired portion in accordance with a position of a pointer thereof. In contrast, it is difficult for a user to do so with a remote controller having limited buttons.

Similarly, it is also difficult for a user to designate, with a remote controller, information displayed on a specific position, such as a URL indicated as a meta information piece.

Furthermore, as to a small-sized screen having a small number of pixels, there is a method to display only part of meta information using a scrollbar, etc. However, this method is often inconvenient to a user, for the user needs to display icons, etc. for specifying display area portions on the screen, and such an operation is complicated.

The map display device pertaining to the present invention is characterized by that a map is displayed by a method whereby a user can easily specify a portion or a position on the displayed map even with a remote controller. That is to say, in the light of the differences in the operability between a remote controller and a pointing device such as a mouse, a map is displayed in line with the operation manner of a remote controller.

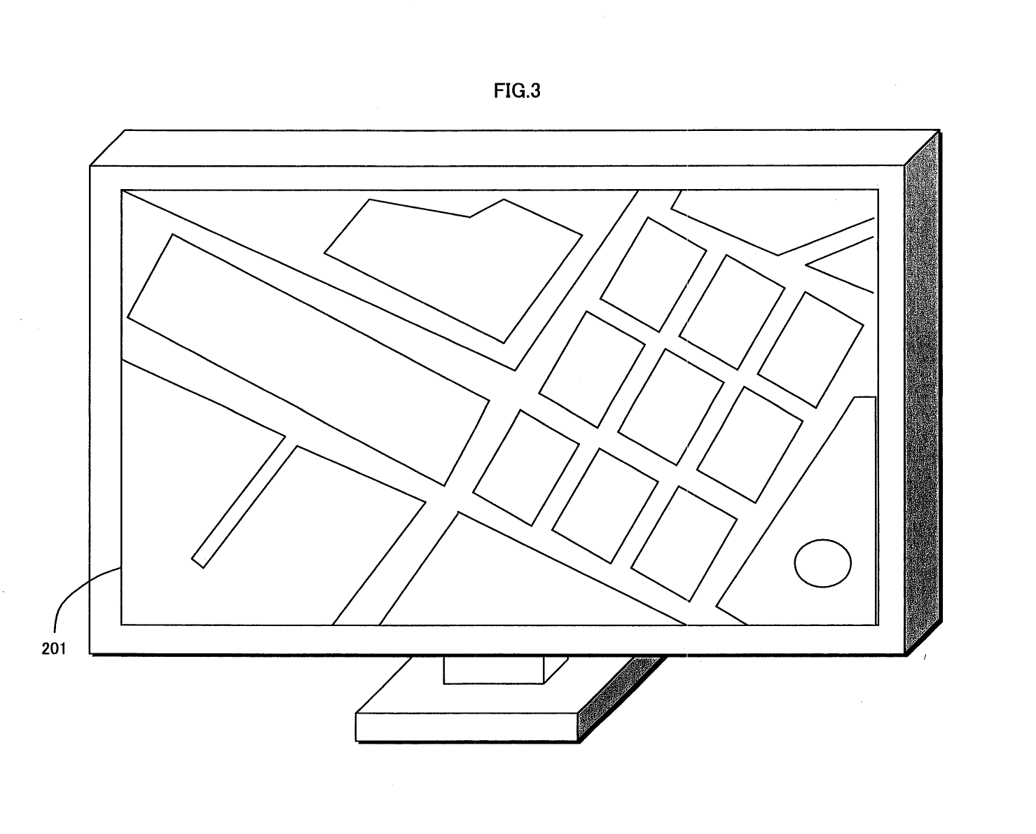

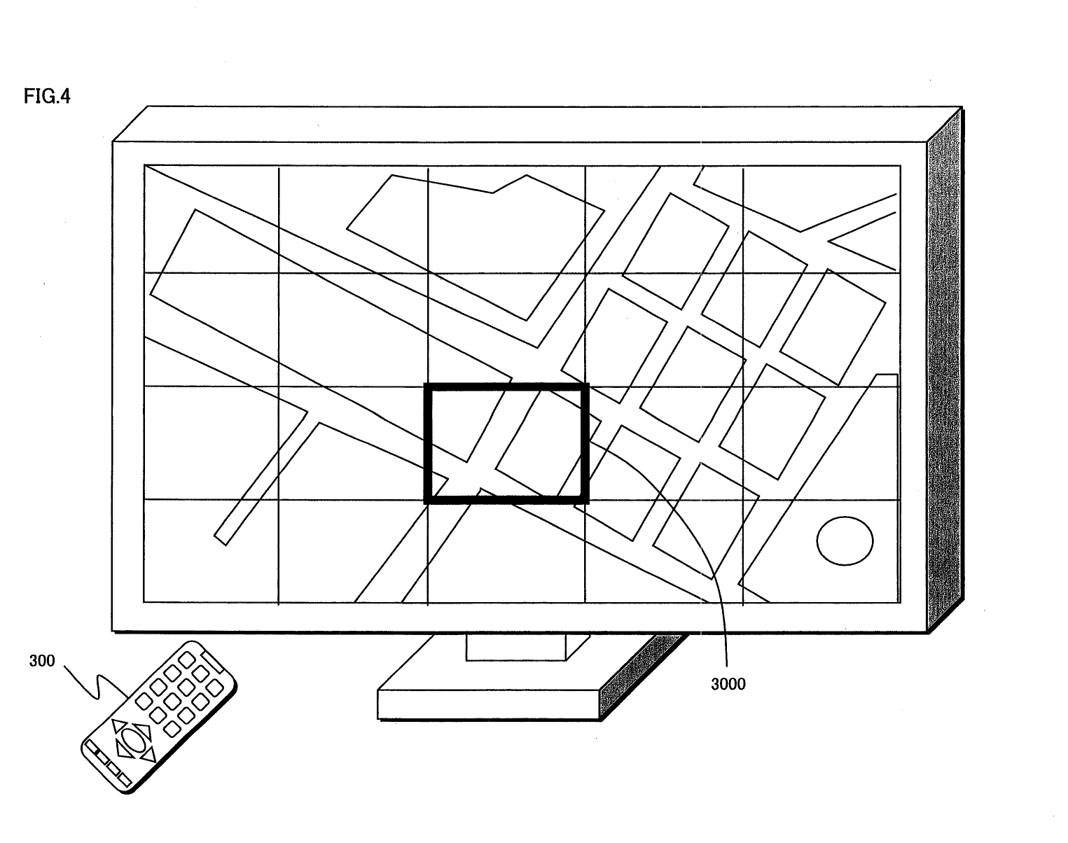

More specifically, a screen 201, included in a display 200 and displaying a map shown in FIG. 3, is divided into a plurality of display area portions as shown in FIG. 4. By pressing the direction buttons (301, 302, 303, 304) of the remote controller, a user moves a cursor in the portions one by one to focus 3000. By pressing the enter button 305, a user selects a specific one of the display area portions.

Likewise, the map display device pertaining to the present invention is characterized by that display of meta information and specification of URL are performed in line with the operation manner of a remote controller.

More specifically, meta information pieces associated with positions in a selected portion are not displayed side by side with one another, but are superimposed with one anther on a map for display, for example. Thus, according to the present invention, even the size of a screen is small, a user can easily understand meta information pieces.

### [Selecting Method of Map Area Using Remote Control]

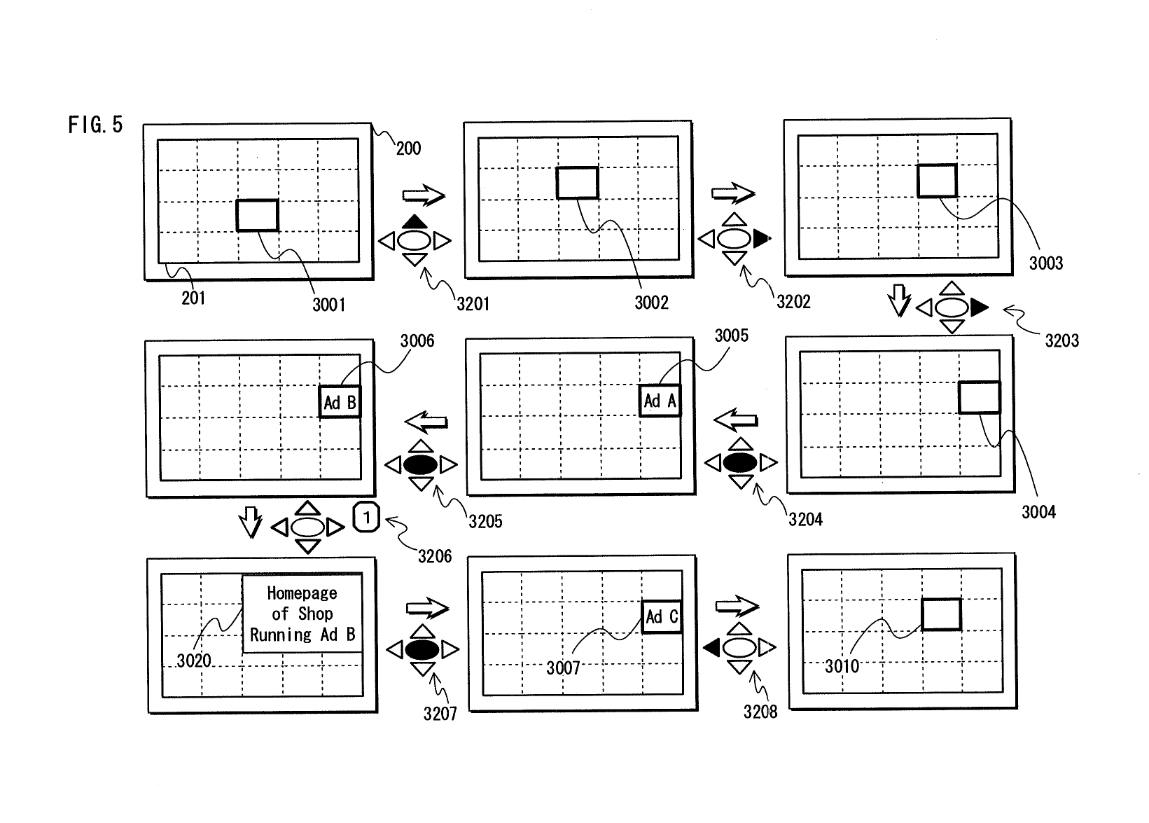

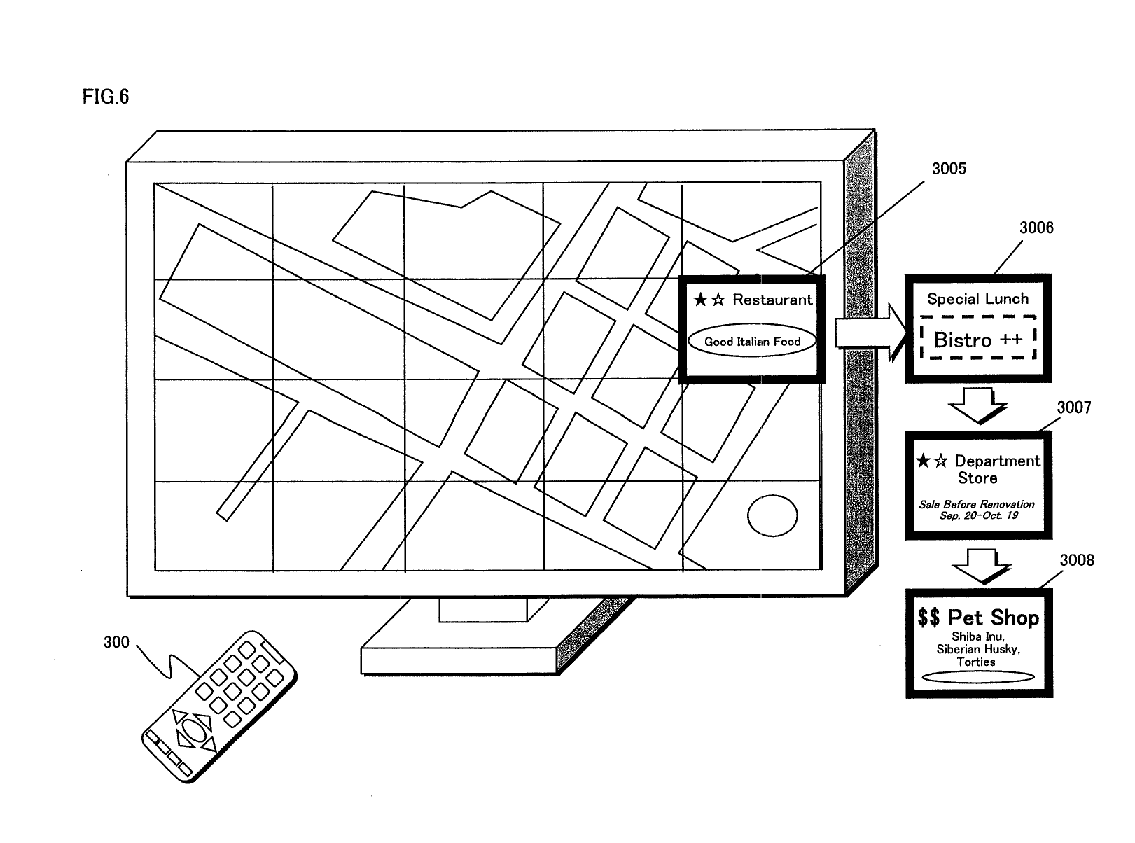

Here, with the use of FIGS. 5 and 6, a brief description is given of a method to select a specific portion on a map with a remote controller and a method to display meta information.

FIG. 5 shows transitions of the screen 201. It is assumed that the transitions take place on the screen 201 in the order shown by the white arrows, and that direction buttons and an enter button of the remote controller are provided below each white arrow. It is assumed that the blackened keys show that they have been pressed. Hereinafter, the direction buttons and the enter button are collectively referred to as “remote controller buttons”.

It is assumed that a map is displayed on the screen 201, and that the map is divided into a plurality of portions in a grid pattern. Here, for the sake of the description, the borders of the display area portions are shown by the dotted lines. Practically, however, these borders do not have to be displayed.

FIG. 6 shows transitions of the meta information pieces. Here, each meta information piece is an advertisement for a shop located in the display area portion. FIG. 6 shows that four pieces of meta information (3005, 3006, 3007, 3008) are sequentially displayed in the same display area portion.

In the upper left of the screen 201 in FIG. 5, a portion 3001 is focused on. Here, when an upper-direction button is pressed (see the remote controller button 3201), a portion 3002 above the portion 3001 is focused on. Subsequently, when a right-direction button is pressed (see remote controller button 3202), a portion 3003 that is on the right of the portion 3002 is focused on. Similarly, when the right-direction button is further pressed (see the remote controller button 3203), a portion 3004 that is on the right of the portion 3003 is focused on.

When the enter button is pressed then (see the remote controller button 3204), a meta information piece associated with the position in the portion 3004, which is “ad A (3005)” here, is displayed on the portion 3004 (see meta information 3005 in FIG. 6).

When the enter button is further pressed (see the remote controller button 3205), another meta information piece associated with the position in the portion 3004, which is “ad B (3006)” here, is displayed on the portion 3004 (see meta information 3006 in FIG. 6).

When a channel button “1” is pressed (see channel button 3206) while the “ad B (3006)” is on display, a URL screen (3020) relating to the URL of the “ad B (3006)” is displayed. For example, a homepage or the like of a shop running the “ad B” is displayed.

Subsequently, when the enter button is pressed again (see the remote controller button 3207), another meta information piece associated with the position in the-portion 3004, which is “ad C (3007)” here, is displayed on the portion 3004 (see meta information 3007 in FIG. 6).

Here, when a left-direction button is pressed (see the remote controller button 3208), a portion 3010 that is on the left of the portion 3004 is focused on. Then, “ad C (3007)” displayed on the portion 3004 is deleted, and only the map appears.

As described above, with the direction buttons and the enter button, a user selects a specific portion on the map, displays pieces of the meta information one after another, and displays the screen of a URL relating to each piece of the meta information.

The following describes a TV that is an embodiment of the map display device pertaining to the present invention, with the use of the drawings.

### [Configuration]

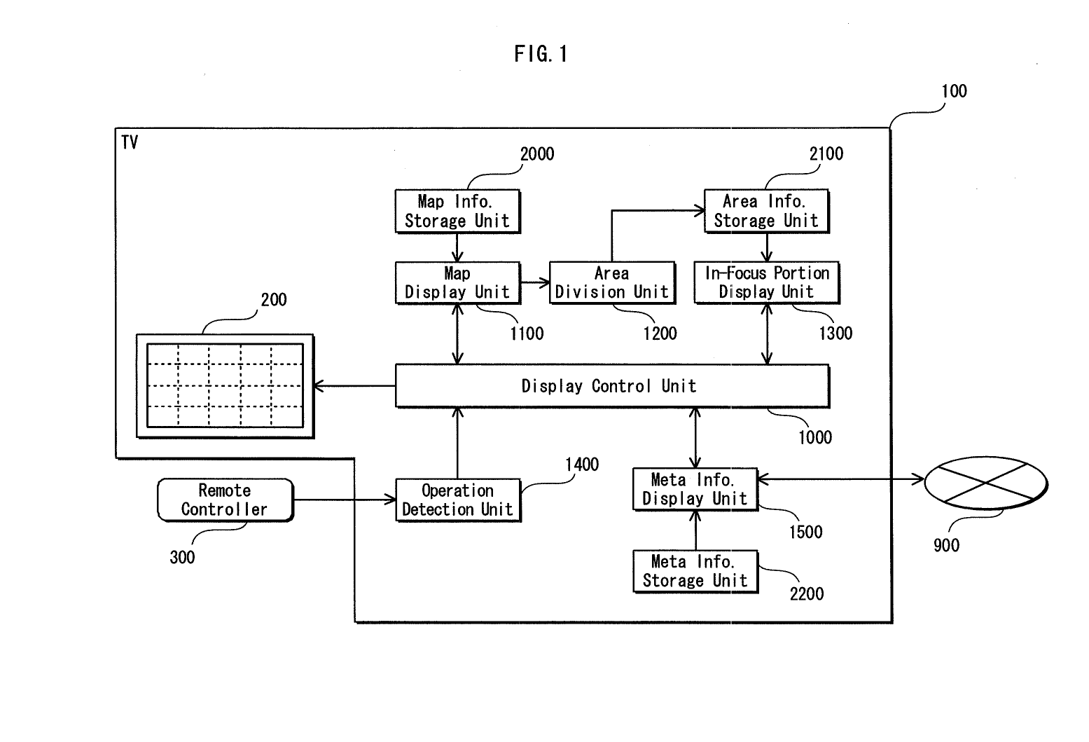

FIG. 1 is a functional block diagram showing the configuration of a TV 100.

The TV 100 has a display 200 such as a liquid-crystal display, a display control unit 1000, a map display unit 1100, an area division unit 1200, an in-focus portion display unit 1300, an operation detection unit 1400, a meta information display unit 1500 connectable to the internet 900, a map information storage unit 2000, an area information storage unit 2100, and a meta information storage unit 2200.

The TV 100 also externally has the remote controller 300 which is an interface with a user.

The functional block diagram shows only functional blocks relating to the present invention. The fundamental functions of the TV 100, such as a receiving function of a TV video signal, are not illustrated.

The display control unit 1000 has the function of controlling the display of a map and meta information. More specifically, the display control unit 1000 performs the following control. For example, the display control unit 1000 analyzes the operation of the remote controller detected by the operation detection unit 1400, displays a map, focuses on a indicated display area portion, and the like.

In response to an instruction from the display control unit 1000, the map display unit 1100 has the function of reading map information from the map information storage unit 2000, and displays it on the display 200 through the display control unit 1000. When displaying a map, the map display unit 1100 has the function of passing information of the latitudes and longitudes on the map to the area division unit 1200.

The area division unit 1200 has the function of associating the screen of the display 200 and a map to be displayed. More specifically, the area division unit 1200 divides the screen of the display 200 into a plurality of portions in accordance with a predetermined dividing method. Hereinafter, the portions as divided above are referred to as “display area portions”. In this embodiment, it is assumed that the screen is divided in a grid pattern.

The area division unit 1200 associates screen coordinates for each display area portion and the latitude and longitude of a map received from the map display unit 1100, and stores the data association as area division information in the area information storage unit 2100. The stored area division information is described in the item [Data].

The in-focus portion display unit 1300 has the function of moving the focus of a display area portion when receiving an instruction from the display control unit 1000. Here, to focus means to highlight a display area portion specified by a user such that the user can visually recognize the portion. In this embodiment, although the periphery of the display area portion is shown by the heavy line, it may be shown in another manner.

The operation detection unit 1400 obtains the user operation performed on the remote controller 300, and notifies it to the display control unit 1000.

The meta information display unit 1500 has the function of reading out, from the meta information storage unit 2200, a meta information piece corresponding to a request from the display control unit 1000, and displays it through the display control unit 1000. The meta information display unit 1500 also has the function of displaying a URL screen associated with the currently displayed meta information piece in response to the request from the display control unit 1000.

The map information storage unit 2000 has the function of storing therein map information. The meta information storage unit 2200 has the function of storing therein meta information. It is assumed that the map information and the meta information are timely updated through the internet. It is assumed that, as necessary, data is obtained through the internet. In such a case, any interface for connecting to the network, and any protocol, etc. used for obtaining data are applicable.

The map information includes position data (e.g. combination of the latitude and the longitude) that can identify any position in a rendered portion on the map. For example, the map information includes a pair of latitude and longitude data and a rendering unit of bit map data of an image contained therein or vector data of the image. The latitude and longitude data specifies the position of the image.

The area information storage unit 2100 has the function of storing therein area division information.

Here, part or all of the processes performed by the units such as the display control unit 1000 are implemented by various types of programs executed by the CPU (unillustrated).

### [Data]

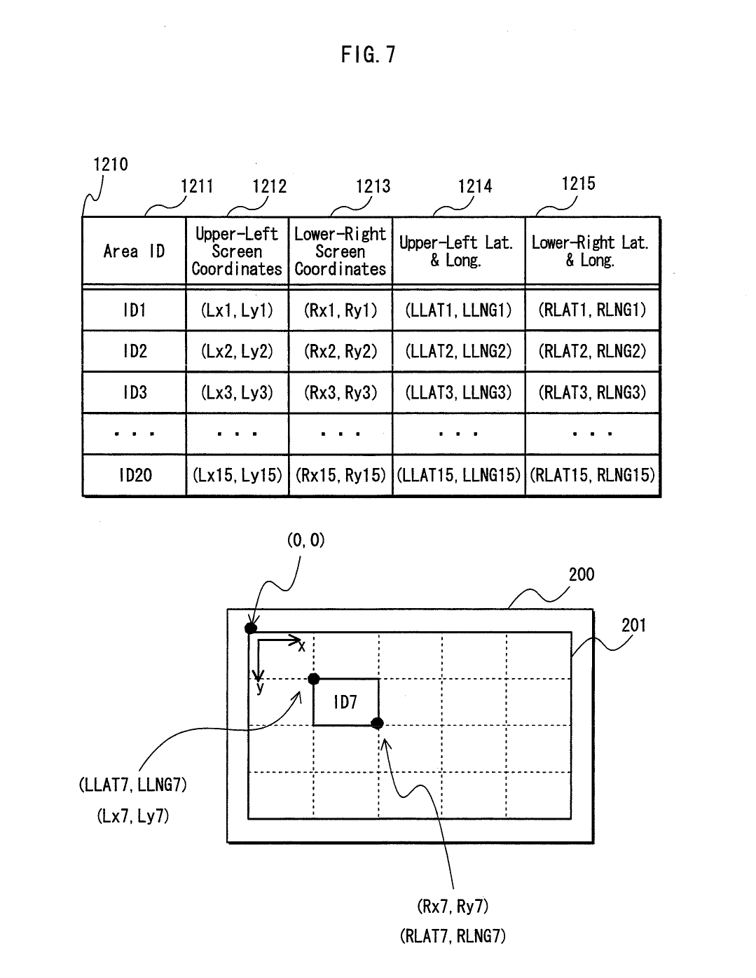

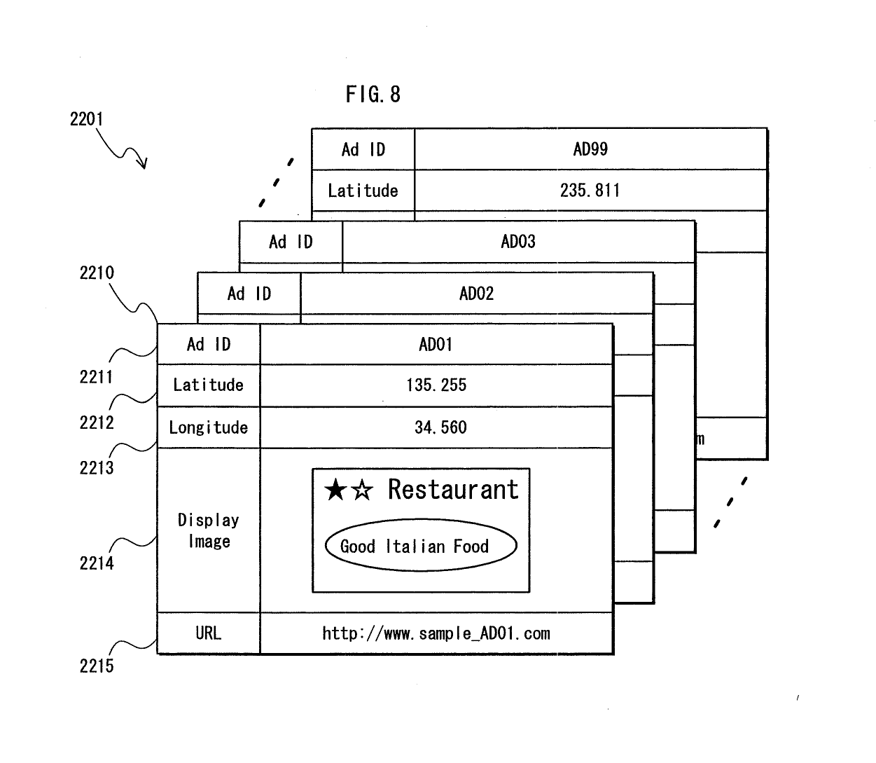

With the use of FIGS. 7 and 8, main data used by the TV 100 is described as follows.

FIG. 7 shows the structure and an example of contents included in area division information 1210.

The area division information 1210 is stored in the area information storage unit 2100. The area division information 1210 is created and stored by the area division unit 1200.

The area division information 1210 associates the screen coordinates and the latitude and longitude of each display area portion. The screen coordinates are used for focusing on a display area portion. The latitude and longitude are used for searching for a meta information piece in the display area portion.

Accordingly, each time the area division unit 1200 receives a creation request for the area division information 1210 by receiving the latitude and longitude from the map display unit 1100, the area division unit 1200 creates the area division information 1210. The map display unit 1100 makes the creation request by passing the latitude and longitude to the area division unit 1200 each time a map to be displayed on the screen 201 of the display 200 is changed.

In this embodiment, it is assumed that the screen 201 of the display 200 is divided into twenty portions in a grid pattern (see FIG. 4, etc.), and that the screen coordinates of each display area portion is determined in advance.

The area division information 1210 includes an area ID 1211, upper-left screen coordinates 1212, lower-right screen coordinates 1213, upper-left latitude and longitude 1214 and lower-right latitude and longitude 1215.

The area ID 1211 is an identifier of a display area portion. In this embodiment, “ID 1” and “ID 2”-“ID 5” are assigned from the left to right end of the first row of the display area portions. “ID 6”-“ID 10” are assigned from the left to right end of the second row of the display area portions. It is assumed that “ID 20” comes the last of the display area portions.

The upper-left screen coordinates 1212 and the lower-right screen coordinates 1213 each show the screen coordinates of the display area portion. The corner at the upper left of the screen 201 is expressed by the coordinates (0, 0). Hereinafter, the upper-left screen coordinates 1212 and the lower-right screen coordinates 1213 are collectively referred to as “screen coordinates of a display area portion”.

The upper-left latitude and longitude 1214 and the lower-right latitude and longitude 1215 each indicate the latitude and longitude of a display area portion. Hereinafter, they are collectively referred to as “latitude and longitude of a display area portion”.

For example, the lower drawing in FIG. 7 shows the display 200. This drawing shows the screen coordinates, the latitude and longitude of the display area portion whose area ID is “ID 7”. It shows that the screen coordinates of the display area portion whose ID is “ID 7” are “ (Lx7, Ly7), (Rx7, Ry7)” and that the latitude and longitude thereof are “(LLAT7, LLNG7) (RLAT7, RLNG7)”.

Next, FIG. 8 shows the structure of a meta information group 2201 and an example of contents included in the meta information group 2201.

This meta information group 2201 is stored in the meta information storage unit 2200, referred to by the meta information display unit 1500 and displayed on the screen 201. This meta information group 2201 is updated through the internet.

The meta information group 2201 contains a plurality of meta information pieces 2210. The meta information pieces 2210 are respectively associated with positions on the map.

Each meta information piece 2210 contains an ad ID 2211, a latitude 2212, a longitude 2213, a display image 2214 and a URL 2215.

The ad ID 2211 is an identifier of a meta information piece. In this embodiment, it is assumed that the meta information piece is an advertisement for a shop, etc. A meta information piece may be other than an advertisement.

The latitude 2212 and the longitude 2213 show a position on the map associated with a meta information piece. In this embodiment, since the meta information piece is an advertisement for a shop, etc., the latitude 2212 and the longitude 2213 show the position of the shop.

The display image 2214 shows an image to be displayed on the display 200. Practically, image data in a format of JPEG or the like is stored. Here, for the sake of the description, an image to be displayed is shown.

The URL 2215 is a URL relating to a meta information piece. In this embodiment, for example, it is a URL of a homepage, etc. of a shop.

### [Operation]

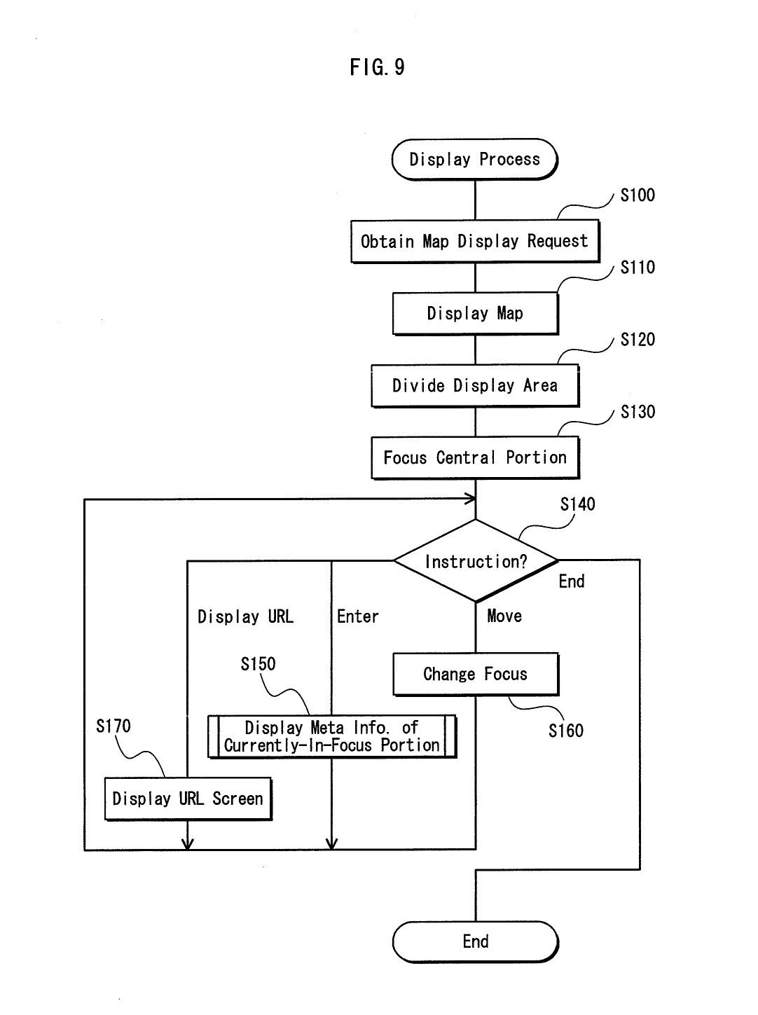

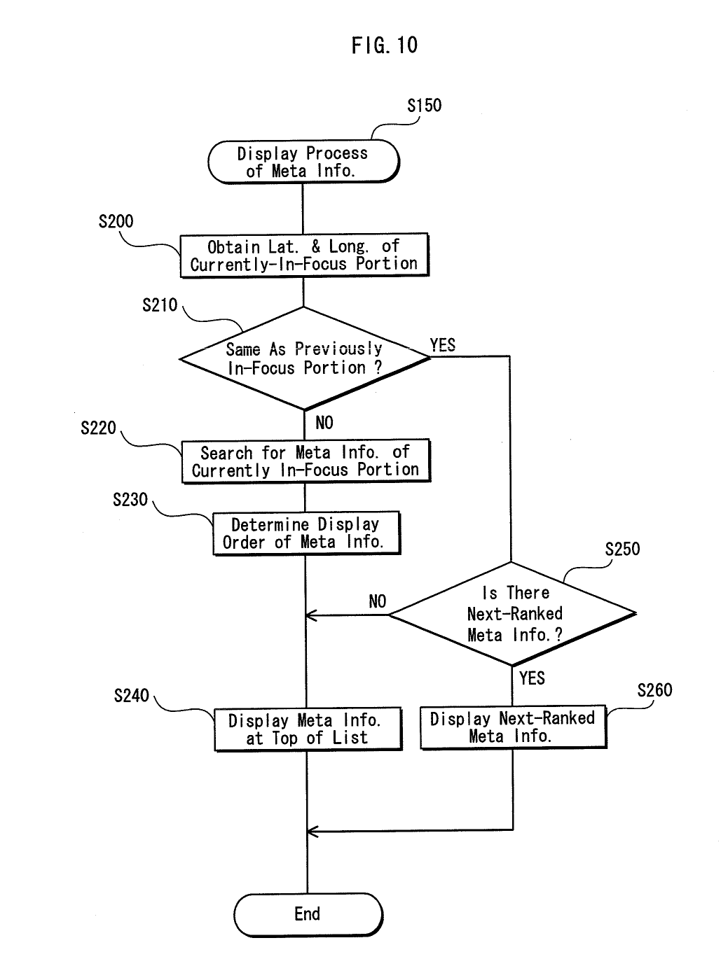

With the use of FIGS. 9 and 10, a description is given of the operation of the TV 100 pertaining to the present invention as follows.

FIG. 9 is a flow chart showing a display process of a map.

First, a user presses a map display button included in a remote controller 300.

The operation detection unit 1400, having detected the pressing of the map display button, notifies a detection result to the display control unit 1000 (Step S100).

The display control unit 1000, having received the notification, requests the map display unit 1100 to display a map. In this embodiment, it is determined in advance which map is to be displayed. Note that the present invention is not limited to this. A user may specify which map is to be displayed.

Also, a map display device such as a TV may have a GPS to display a map of the surrounding area of the device, or the like.

Upon receiving the display request, the map display unit 1100 reads out, from the information storage unit 2000, a map corresponding to the request, and displays it on the display 200 through the display control unit 1000 (Step S110).

When displaying the map, the map display unit 1100 passes the latitude and longitude of the map to be displayed, and requests the area division unit 1200 to divide the screen into display area portions. The latitude and longitude of the map to be displayed as well as graphical information of the map are stored in the map information storage unit 2000.

The area division unit 1200, having received the dividing request, calculates, for each display area portion, a latitude and longitude of the map that correspond to the screen coordinates based on the received latitude and longitude, and creates the area division information 1210. The created area division information 1210 is stored in the area information storage unit 2100 (Step S120).

After displaying the map on the display 200, the display control unit 1000 requests the in-focus portion display unit 1300 to focus on a display area portion at the start position.

With reference to the area division information 1210 stored in the area information storage unit 1200, the in-focus portion display unit 1300, having received the request, selects one of the display area portions that contains the coordinates of the center of the screen 201 on which the map is displayed, and focuses on the selected display area portion through the display control unit 1000 (Step S130). More specifically, receiving the screen coordinates of the display area portion, the display control unit 1000 displays the heavy-lined rectangle on the display 200 based on the received screen coordinates (see display area portion 3001 in FIG. 5).

The in-focus portion display unit 1300 stores an area ID 1211 of the display area portion in focus in the internal work area.

Subsequently, having detecting the user operation, the operation detection unit 1400 notifies a detected result, which is to say, which button has been pressed, to the display control unit 1000.

If any of the direction buttons (301, 302, 303, 304) is pressed (Step S140: move), the display control unit 1000, having received the notification, instructs the in-focus portion display unit 1300 to move the focus.

According to the type of a direction buttons, which is to say, an instruction to move in the right, left, up or down direction, the in-focus portion display unit 1300, having received the instruction, selects a display area portion adjacent to the display area portion in focus, and focuses on the adjacent display area portion through the display control unit 1000 (Step S160).

On the other hand, if the enter button 305 is pressed (Step S140: enter), a meta information piece associated with the display area portion in focus is displayed (Step S150). This display process is described later with the use of FIG. 10.

If a URL display button is pressed (Step S140: URL display), the display control unit 1000 makes a notification about pressing of the URL display button to the meta information display unit 1500.

If the meta information piece is displayed, the meta information display unit 1500, having received the notification, makes access to the URL 2215 of the meta information piece 2210 and displays an appropriate page of the internet through the display control unit 1000 (Step S170). The meta information display unit 1500 accesses the URL 2215 of the currently displayed meta information piece 2210. Note that the meta information display unit 1500 executes nothing if the meta information piece is not displayed.

If a button for instructing the termination of the map display process is pressed, the meta information display unit 1500 deletes the map and terminates the display process (Step S140: end).

With the use of FIG. 10, a next description is given of the display process of a meta information piece of a display area portion in focus.

FIG. 10 is a flow chart showing the display process of a meta information piece.

Judging that the enter button 305 is pressed, the display control unit 1000 makes an inquiry about the latitude and longitude of the display area portion in focus to the in-focus portion display unit 1300.

The in-focus portion display unit 1300, having received the inquiry, refers to the area division information 1210 stored in the area information storage unit 2100, and passes, to the display control unit 1000, the upper-left latitude and longitude 1214 and the lower-right latitude and longitude 1215 of a display area portion stored in the work area and corresponding to the display area portion in focus identified by the area ID 1211 (Step S200).

The display control unit 1000, having received the latitude and longitude of the display area portion, passes the latitude and longitude to the meta information display unit 1500 and requests for display of the meta information piece.

The meta information display unit 1500, having received the request, judges whether the received latitude and longitude are the same as those of the display area portion that has been requested immediately before the received request. More specifically, when receiving the request for display of the meta information piece, the meta information display unit 1500 stores the received latitude and longitude in the internal work area. The meta information display unit 1500 compares the stored latitude and longitude with the received ones. If they match each other, the meta information display unit 1500 judges that the received latitude and longitude belong to the same display area portion. If not, the meta information display unit 1500 judges the received latitude and longitude belong to a different display area portion.

If the meta information display unit 1500 judges that the received latitude and longitude are different from the previously requested ones, which is to say, if they belong to a different display area portion (Step S210: NO), the meta information display unit 1500 searches for the meta information group 2201 based on the received latitude and longitude (Step S220). The meta information display unit 1500 extracts the meta information pieces 2210 belonging to a display area portion specified by the received latitude 2212 and longitude 2213.

Afterwards, the meta information display unit 1500 determines the display order of the extracted meta information pieces 2210 and makes a list. More specifically, the list shows the ad IDs 2211 and is stored in the internal work area (Step S230). For example, the display order of the ad IDs 2211 is stored in the following order: “AD 01”, “AD 12”, and “AD 22”. There are several methods to determine the display order of meta information pieces. Typical one of the methods is to display meta information pieces in the order of the search keyword ranking. That is to say, the lower ranking a meta information piece has, the more number of the switching operations are required to display the meta information piece. The switching operation here is to press the enter button.

Subsequently, the meta information display unit 1500 reads out a display image 2214 of the meta information piece 2210 having the ad ID 2211 at the top of the created list, and displays it through the display control unit 1000 (Step S240). The meta information display unit 1500 stores which number of the meta information piece 2210 on the list is currently displayed.

If the meta information display unit 1500 judges that the latitude and longitude are the same as the previously requested ones, which is to say, if the display area portion is the same as the previously requested one (Step S210: YES), and if the ad ID 2211 ranked next on the list follows an ad ID of the currently displayed meta information piece 2210 (Step S250: YES), the meta information display unit 1500 reads out the display image 2214 of the meta information piece 2210 corresponding to the next-ranked ad ID 2211, and displays it through the display control unit 1000 (Step S260). If the next-ranked ad ID 2211 on the list does not exist (Step S250: NO), the meta information display unit 1500 reads out the display image 2214 of the meta information piece 2210 identified by the ad ID 2211 at the top of the list, and displays it through the display control unit 1000 (Step S240).

### [Modification]

In Embodiment 1, only a meta information piece associated with a display area portion is displayed. However other information (hereinafter, referred to as “random information”) may also be displayed.

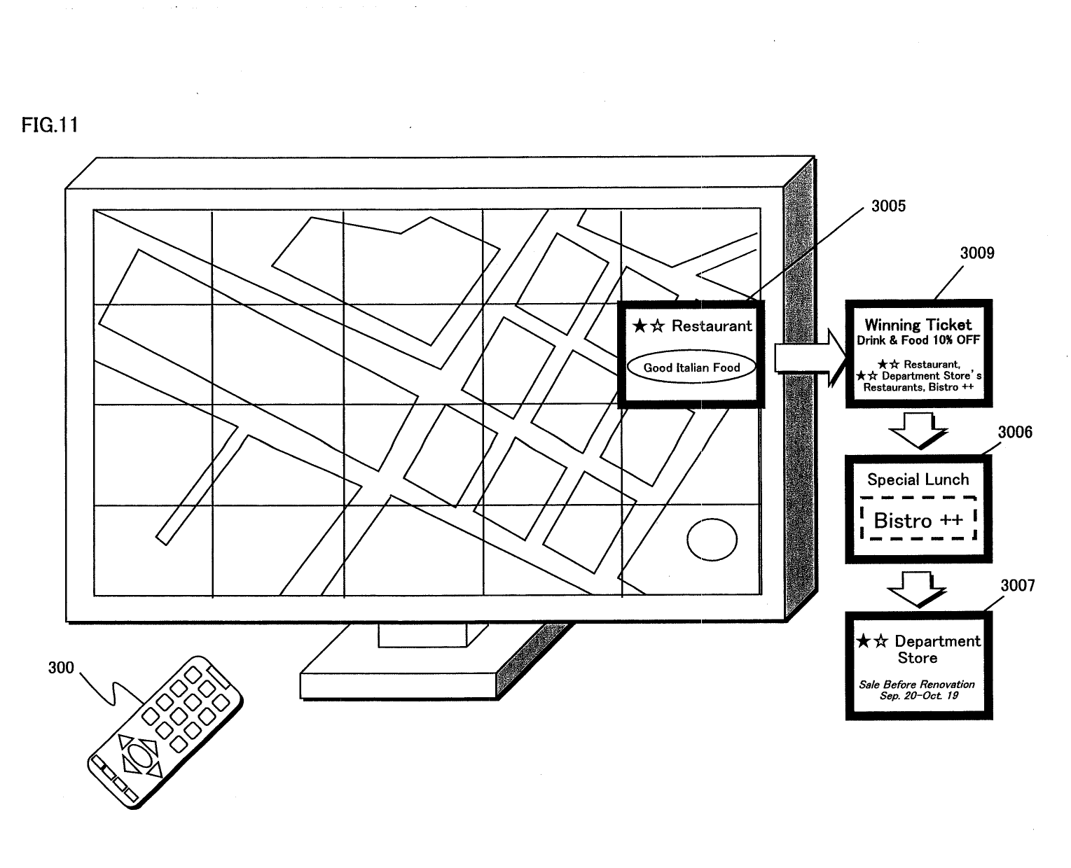

An example of a piece of such random information is “winning ticket (3009)” in FIG. 11. Here, the “winning ticket (3009)” is interposed between the ad 3005 and the ad 3006 for display.

As with a meta information piece, a random information piece may be associated with a position or with another information irrespective of a position. For example, a random information piece may be an advertisement for a product or a coupon of a shop. Random information is stored in advance in the meta information storage unit 2200, and is timely updated through the internet.

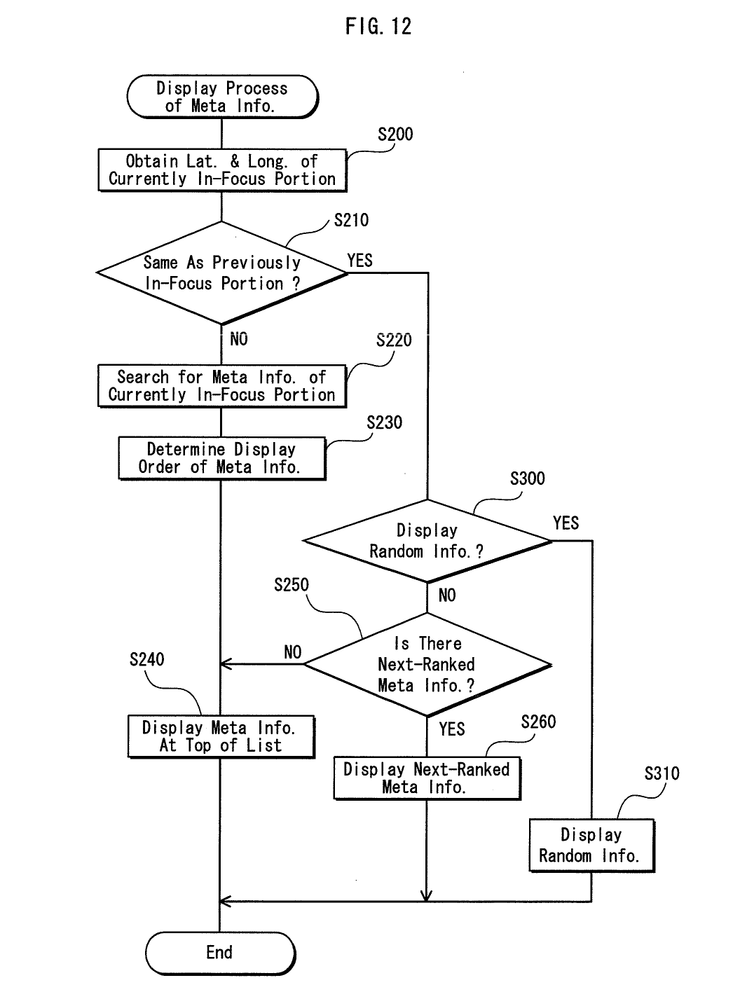

FIG. 12 is a flow chart showing the display process of a random information piece.

FIG. 12 shows basically identical process with the meta information display process of Embodiment 1 described with FIG. 10. Here, only the differences therebetween are described.

Steps S200-S260 are identical with those in FIG. 10.

The meta information display unit 1500 determines whether to display a random information piece before displaying the next-ranked meta information piece, based on the list in which the display order of the meta information pieces is specified (Step S300). It is determined based on the constant probability R whether the prepared random information piece is displayed by breaking in the order on the list.

If the meta information display unit 1500 determines to display the random information piece (Step S300: YES), the meta information display unit 1500 displays the random information piece (Step S310). If the meta information display unit 1500 determines not to display the random information piece (Step S300: NO), the meta information display unit 1500 judges whether there is a next-ranked meta information piece (Step S250). Thus, the meta information display unit 1500 displays the next-ranked meta information piece or the top-rank meta information piece (Steps S260, S240).

Thus, “winning ticket” information or the like, which brings benefit to a user, is mixed at random in definite proportions in the display order of meta information pieces. This can produce an effect of igniting a user to refer to the meta information pieces.

Here, the random information is displayed based on the established probability R. However, needless to say, the random information may be displayed based on the following condition, for example. (a) Random information is displayed each time the switch input unit 308 has performed a predefined number of trials. (b) Random information is displayed each time the area indication unit 303 has given a predefined number of trials. (c) Random information is displayed if a specific predetermined operation is performed with a remote controller. (d) Random information is displayed if a service has offered for a predetermined time. (e) If random information is once displayed, it is not displayed after a predetermined time. Needless to say, any combination of these conditions is applicable, or other display condition may also be set.

### Embodiment 2

### [Overview]

According to Embodiment 1, the display area portions are obtained by dividing the screen 201 in a grid pattern. According to Embodiment 2, on the other hand, the display area portions are obtained by dividing the screen 201 in view of a map.

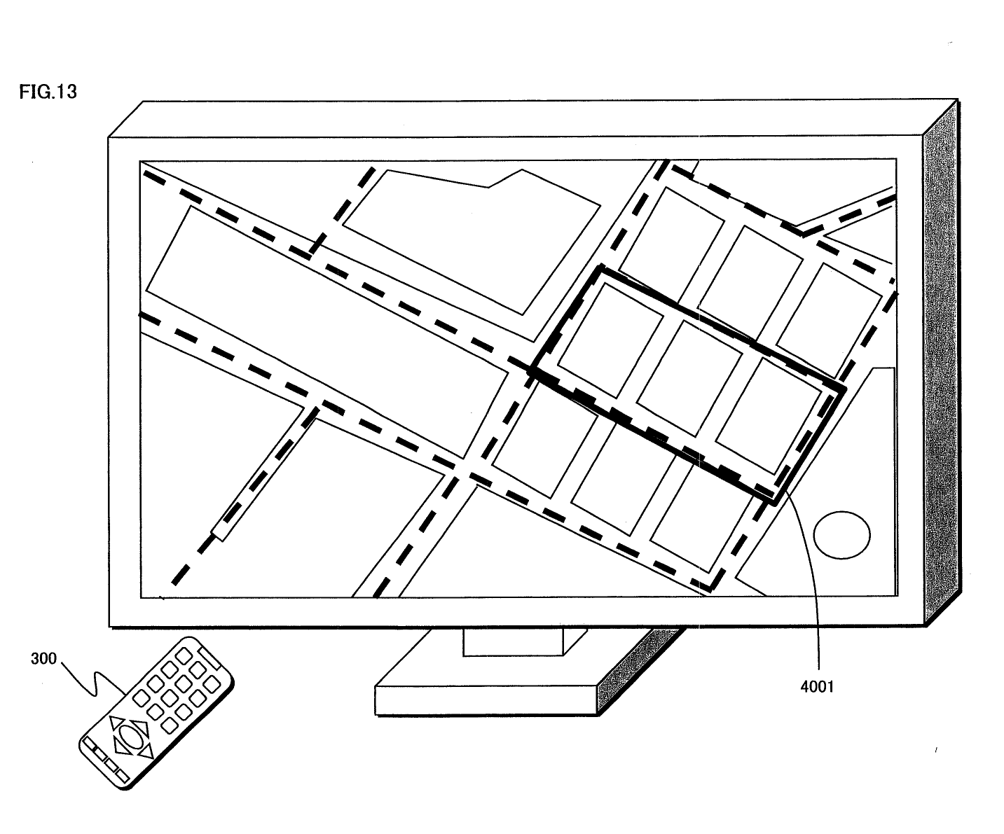

FIG. 13 shows a case where a block in an urban area is displayed as a display area portion 4001. For example, a map is divided according to a town or a school district. Information necessary for this division is included in the map information.

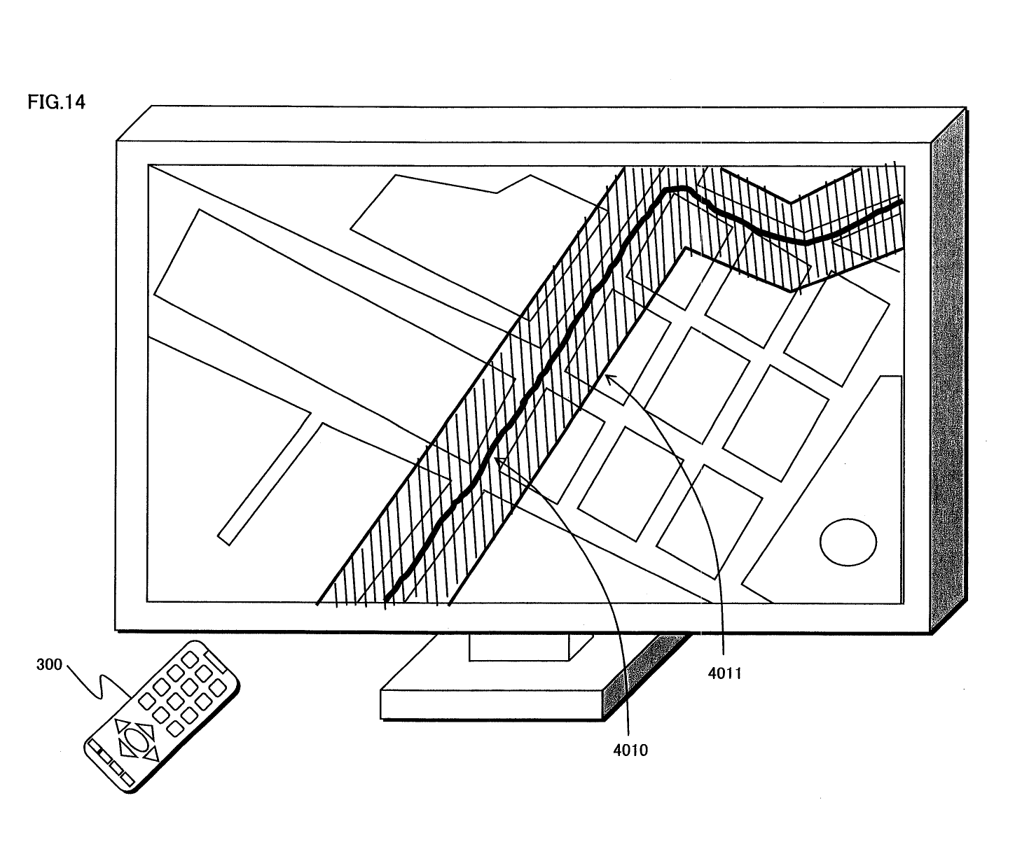

FIG. 14 shows a case where a surrounding area of a route 4010 in a car navigation system is displayed as a display area portion 4011 (shadow portion).

For example, an already-available car navigation device realizes the following mechanism. When a destination is inputted, the routes to the destination are obtained and displayed on the map based on the map information. The present invention may be combined with this mechanism.

A display area portion may be set by a user, or automatically set by the route 4010. For example, when a user goes out, as soon as he seeks the route, he may obtain and display meta information of the surrounding area of the route.

### [Configuration]

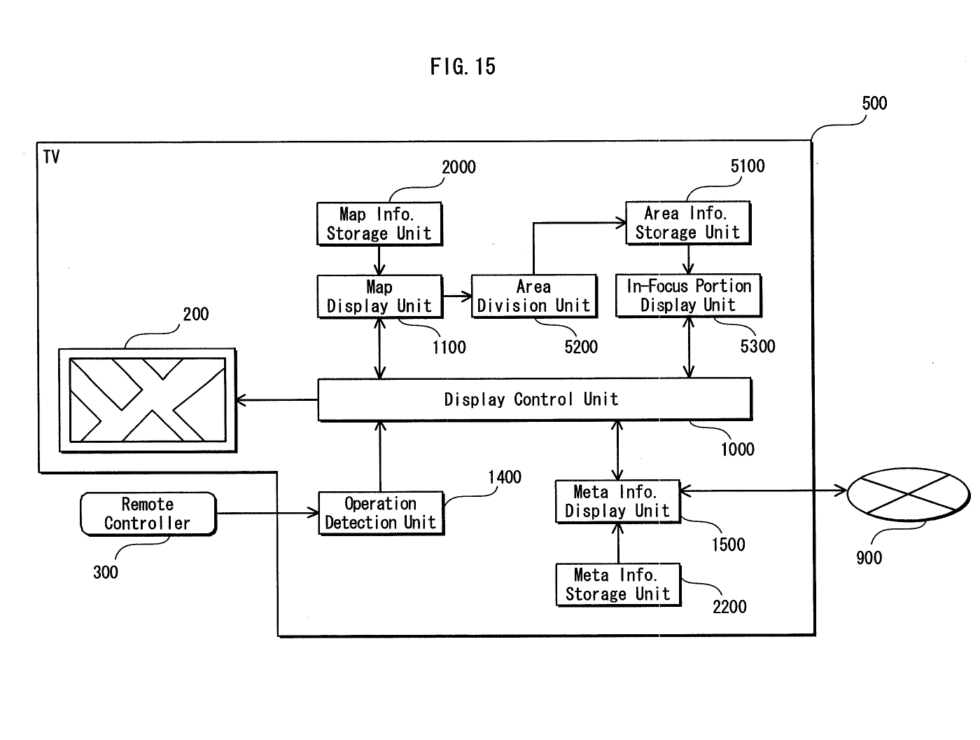

FIG. 15 is a functional block diagram showing the configuration of a TV 500 in accordance with Embodiment 2 of the present invention. The functional blocks of Embodiment 2 are basically identical with those of the TV 100 of Embodiment 1 shown in FIG. 1. Only the functional blocks different from Embodiment 1 are explained.

The functional blocks different therebetween are an area division unit 5200, an in-focus portion display unit 5300 and an area information storage unit 5100.

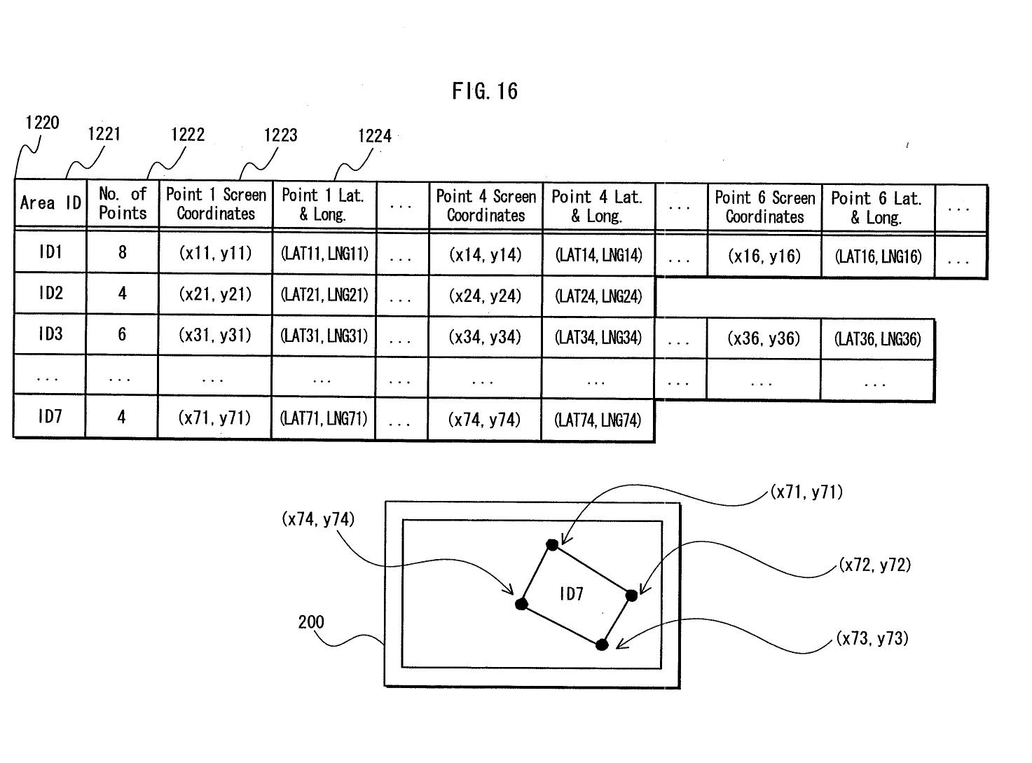

The area division unit 1200 of Embodiment 1 creates the area division information 1210 by dividing the screen 201 into a grid pattern. The area division unit 5200 of Embodiment 2 is different from the area division unit 1200 of Embodiment 1 as follows. Based on a map to be displayed, the area division unit 5200 creates area division information 1220 shown in FIG. 16 by dividing the screen into areas according to urban districts and streets, and stores the area division information 1220 in the area information storage unit 5100.

According to Embodiment 1, the map display unit 1100 passes the latitude and longitude of a map to be displayed to the area division unit 1200. Due to this difference, according to Embodiment 2, the map display unit 1100 passes the latitude and longitude of a map to be displayed as well as information of the map to the area division unit 5200.

In addition, Embodiment 2 is different in that the in-focus portion display unit 5300 focuses on a display area portion in accordance with the shape thereof, as the screen is not divided into display area portions in a grid pattern.

### [Data]

FIG. 16 shows the structure and an example of contents included in the area division information 1220.

The area division information 1220 of Embodiment 2 is similar to the area division information 1210 of Embodiment 1 in FIG. 7 in that screen coordinates and the latitude and longitude of each display area portion are associated. However, the configuration therebetween are different.

According to the area division information 1210 of Embodiment 1, since the display area portion is a rectangle, the display area portion can be expressed by two points, which are the upper-left point and the down-right point. However, Embodiment 2 is different from Embodiment 1 in that a display area portion is a polygon and is expressed by a plurality of points.

The area division information 1220 contains an area ID 1221, the number of points 1222, point 1 screen coordinates 1223, point 1 latitude and longitude 1224, point 2 screen coordinates, point 2 latitude and longitude, and other screen coordinates and latitudes and longitudes for the number of points 1222.

For example, the lower drawing in FIG. 16 shows the display 200. FIG. 16 shows the screen coordinates and the latitude and longitude of a display area portion whose area ID is “ID 7”. The screen coordinates of the display area portion whose ID is ID 7 are “(x71, y71), (x72, y72), (x73, y73), (x74, y74)”.

### [Operation]

The map display process according to Embodiment 2 is basically identical with that of Embodiment 1 shown in FIGS. 9 and 10. Accordingly, here, only the difference therebetween is described.

The difference therebetween is the process when the in-focus portion display unit 5300 focuses on a display area portion upon receiving a request from the display control unit 1000, namely the process of Steps S130 and S160 in FIG. 9.

With reference to the area division information 1210 stored in the area information storage unit 1200, the in-focus portion display unit 5300, having received the request, focuses on a display area portion including the coordinates of the center of the screen 201 on which a map is displayed, and focuses on the display area portion through the display control unit 1000 (corresponding to Step S130 in FIG. 9).

Subsequently, when any of the direction buttons (301, 302, 303, 304) is pressed (Step S140: move), the display control unit 1000 instructs the in-focus portion display unit 1300 to move the focus.

According to a type of the direction button, which is to say an instruction to movie in a right, left, up or down direction, the in-focus portion display unit 1300, having received the instruction, selects a display area portion adjacent to the display area portion in focus, and focuses on the adjacent display area portion through the display control unit 1000 (Step S160).

A method to select a display area portion adjacent to the display area portion in focus is as follows, for example. When an upper-direction button is pressed, a vertical line is drawn from the center of a display area portion in focus in an upward direction, and a display area portion which the vertical line initially intersects is selected as a display area portion that is subsequently to be in focus.

### [Supplemental Remarks]

The embodiments of the present invention are described as above. However, the present invention is not limited to them, and the following modifications can be made.

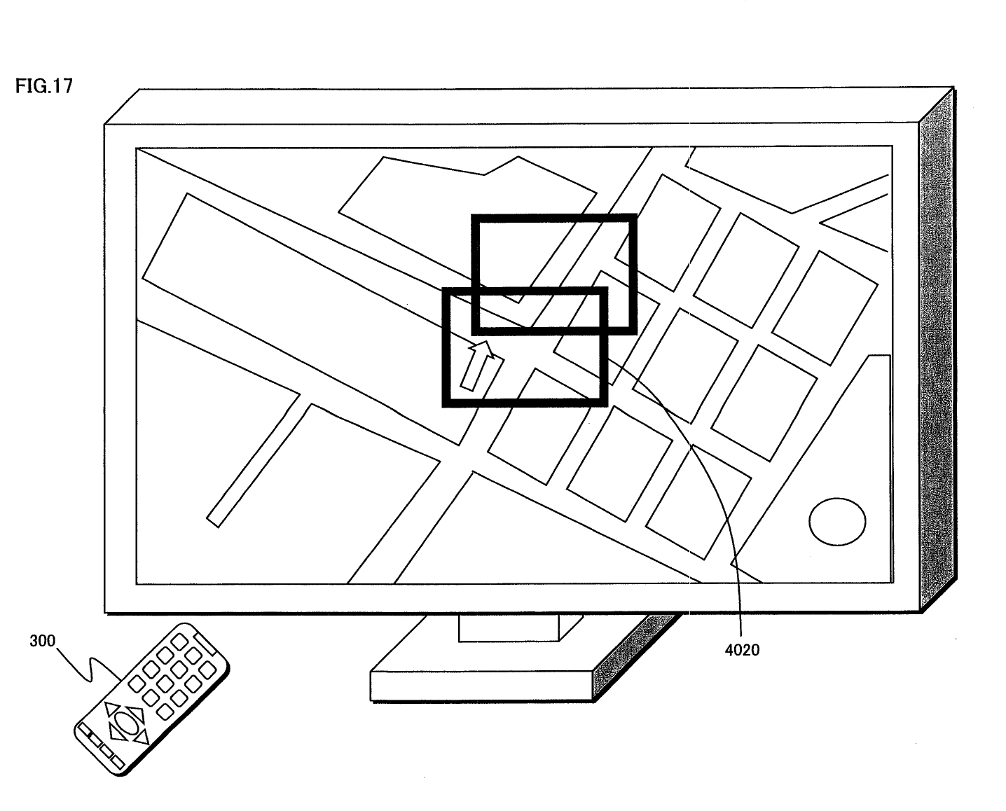

(1) In the embodiments, a display area is divided such that display area portions are not overlapped with one another. However, as shown in FIG. 17, a display area portion may be moved at a predetermined amount, and the partly overlapped display area portion may be in focus.

For example, when the display area portion 4020 is in focus, if the upper-direction button is pressed, an obliquely upward display area portion indicated by the white arrow in FIG. 17 is focused on.

Note that, according to the embodiments, one piece of the meta information is displayed in accordance with the size of a display area portion. However, the following factors may be determined or arranged irrespective of the size and the shape of the display area portion. Such factors include the size and the shape of an image of an advertisement that is displayed as a meta information piece and the number of images displayed in parallel.

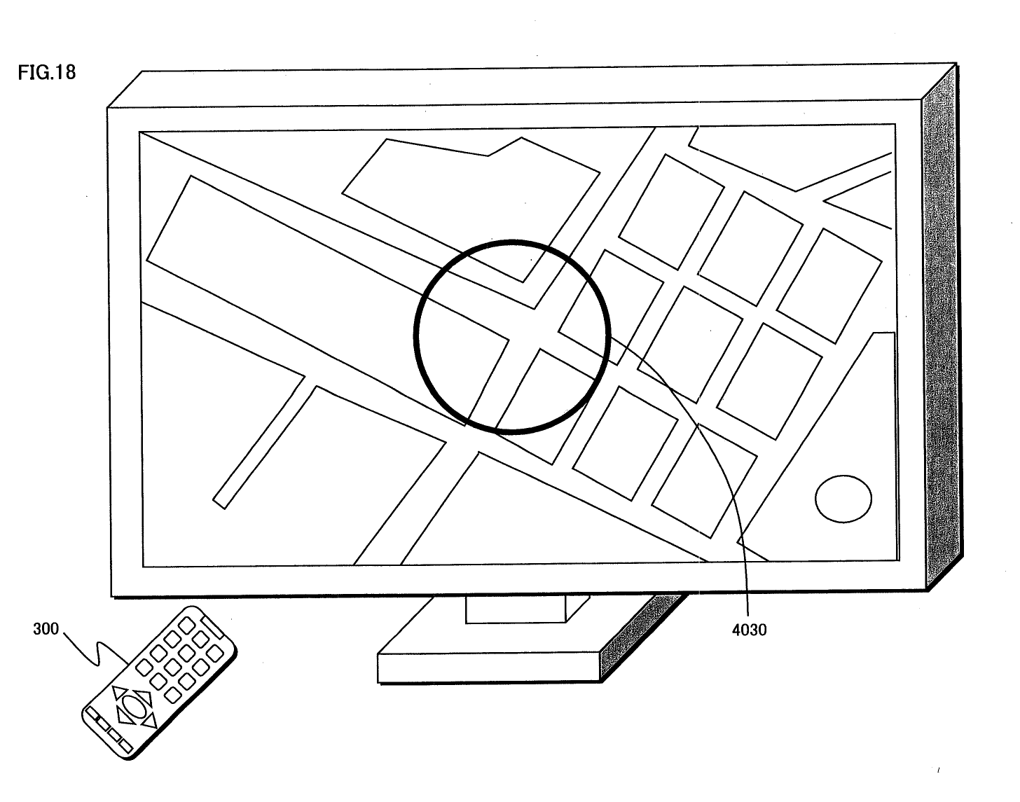

(2) According to the embodiments, a display area portion is a polygon. However, a display area portion may be in another shape, such as a circle as shown in FIG. 18.

In such a case, when a direction button is pressed, the center of the display area portion is moved for a predetermined amount in the indicated direction.

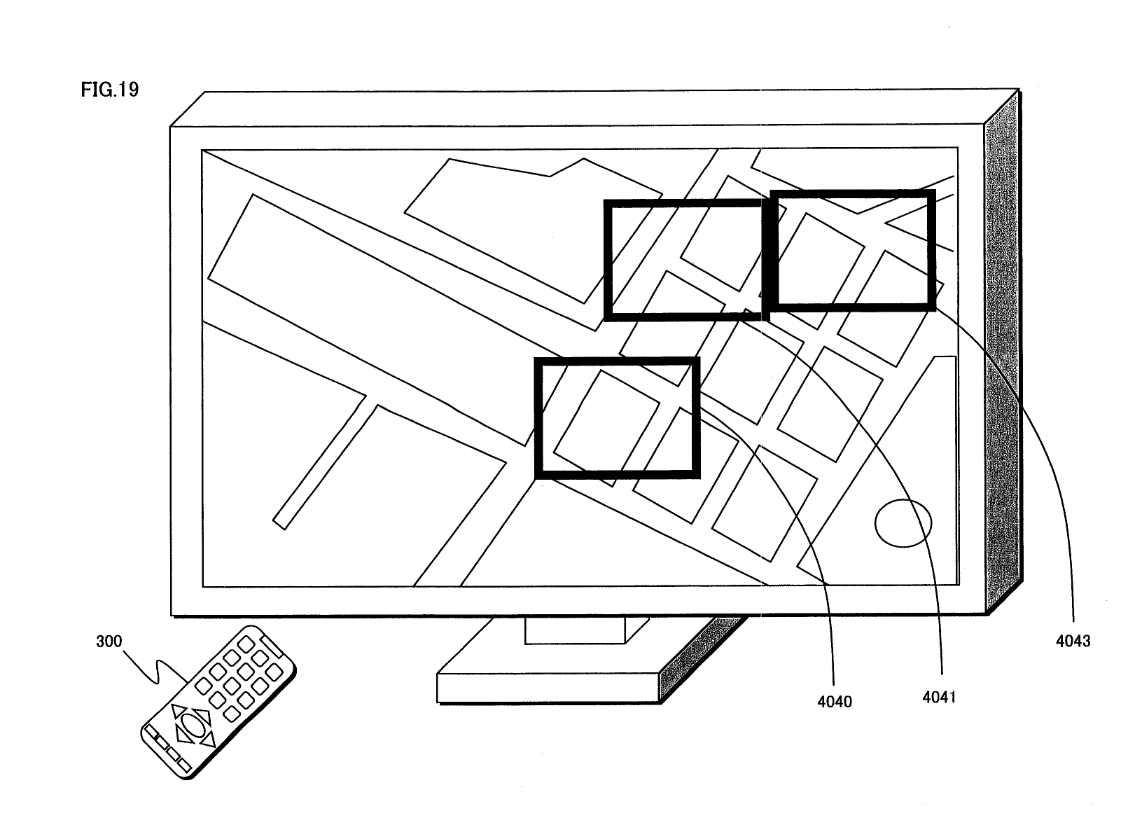

(3) According to the embodiments, only one display area portion is in focus. However, as shown in FIG. 19, a plurality of display area portions may be in focus.

For example, if a direction button is pressed with a “+” button being pressed, a display area portion previously selected remains focused on. The “+” button is a predetermined key for indicating a plurality of display portions at the same time.

In this case, for each of the display area portions, a meta information piece is searched and displayed.

For example, searched pieces of meta information are sequentially displayed one by one. A meta information piece of the display area portion 4040 is displayed on the display area portion 4040. Meta information pieces of the display area portions 4041 and 4043 are respectively displayed on the display area portions 4041 and 4043.

(4) According to the embodiments, a meta information piece is displayed on a display area portion containing a position associated with the meta information piece. However, a meta information piece may be displayed on another display area portion.

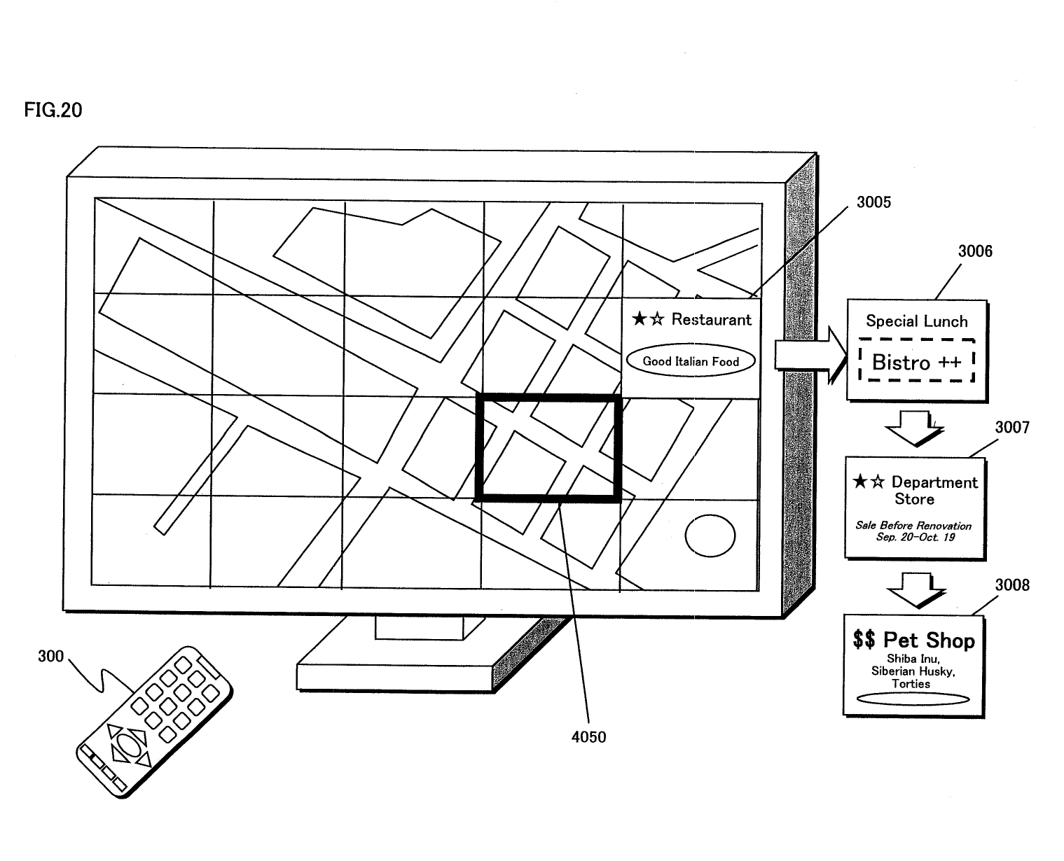

For example, as shown in FIG. 20, a meta information piece of the display area portion 4050 may be displayed on a display area portion on the upper-right side of the screen.

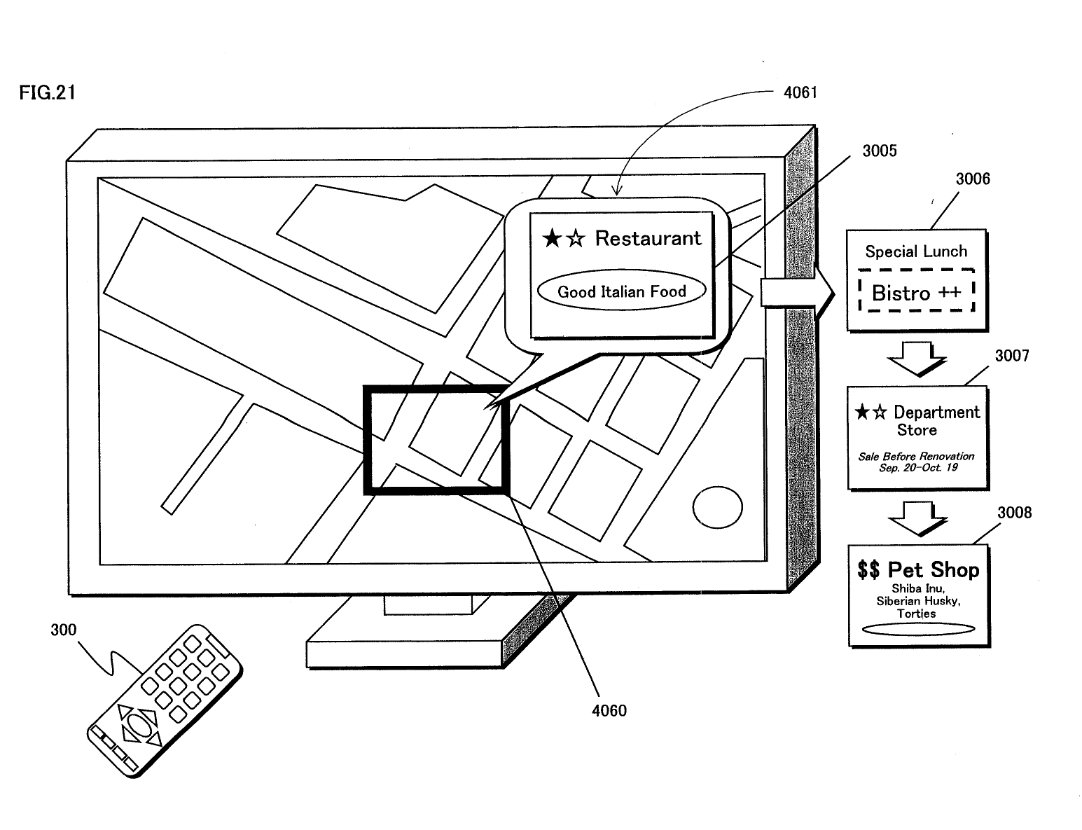

Also, a meta information piece of a display area portion 4060 may be displayed in a balloon 4061 as shown in FIG. 21.

(5) According to the embodiments, a meta information piece is displayed on a display area portion containing a position associated with the meta information piece. However, a meta information piece may be displayed on other display than the display 200 on which a map is displayed.

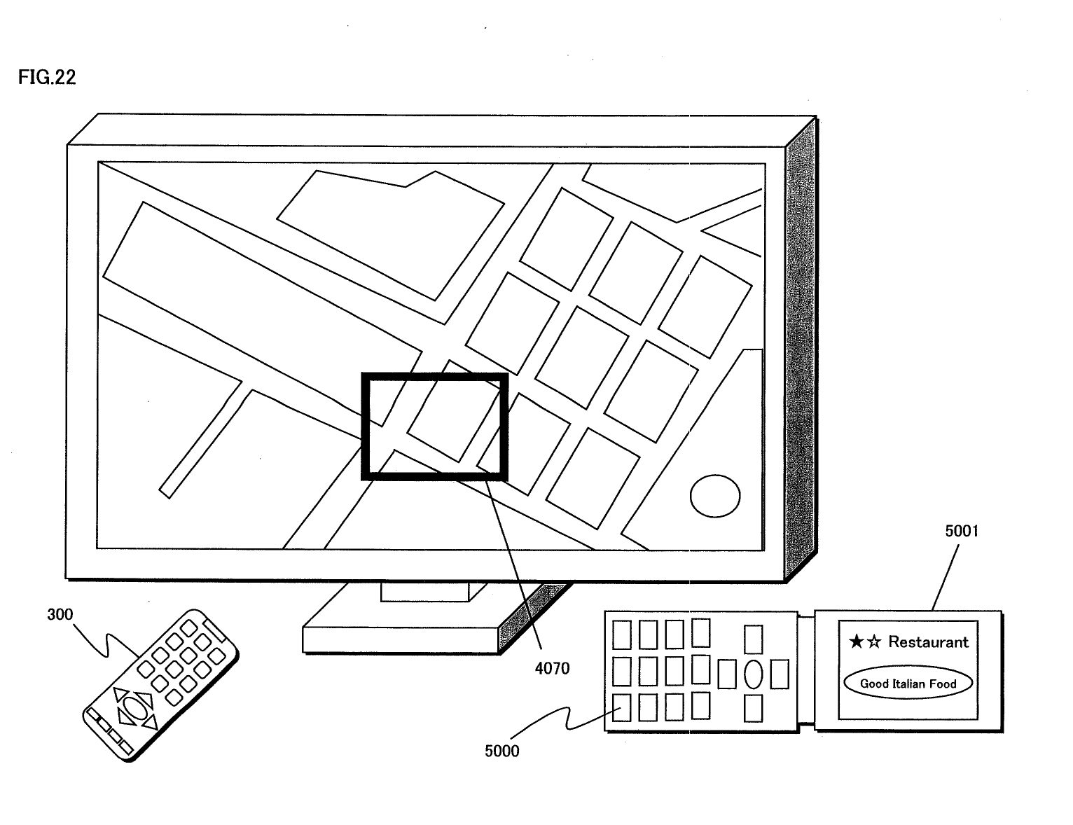

For example, as shown in FIG. 22, a meta information piece associated with a display area portion 4070 may be displayed on a display 5001 of a mobile terminal 5000.

(6) According to the embodiments, map information is timely updated through the internet. However, map information may be stored on an external recording medium which can be mounted on the map display device and whose data is readable by the device. An example of such an external recording medium is a memory recording medium such as an HDD and an SD, and an optical disc medium, such as a DVD, a Blu-ray Disc, and an HD DVD. Alternatively, map information may be stored on any external recording medium

If map information stored in the map information storage unit 2000 is bit-map data, a format of image data is not particularly limited. GIF, JPEG, PNG, BMP, PICT, TIFF, XMF or any other format is applicable. In this case, it is necessary for the map display unit 1100 to include a means for decoding image data and displaying the decoded data as a map image.

Furthermore, map information may include vector data for expressing a map in vector graphics. The vector graphics is a method often used in an applied manner, such as expressing an image in an XML format. Vector data expresses, in numeric data, a start or end position of a line, curvature, thickness, color of a curved line, and color of a surface defined by lines, etc. A format of vector data is not particularly limited, and SVG, PDF, SWF, EPS or an arbitrary format is also applicable. In this case, the map display unit 1100 needs to have a means for drawing vector data.

These are conventional methods. The map display unit 1100 may combine these methods to perform the display.

Some of map reference services implemented on a conventional browser application employ a method using vector graphics to draw details not displayed in an image of a map, based on the image of the map. Needless to say, this method is also applicable.

(8) According to these embodiments, the meta information display unit 1500 creates a list in which the display order of meta information pieces is specified. However, the display order may be specified as follows. A request is transmitted to an external server that is connected to the network and that accumulates meta information in a data base, and consequently, a list of the display order is received from the external server.

Also, a meta information piece that cannot be displayed by the meta information display unit may be removed from the display order, at this stage.

As an example to determine whether a meta information pieces can be displayed or not, the following method is known. It is judged whether a meta information piece contains an image with a specific format, and a meta information piece that does not contain an image with the specific format is removed.

(9) According to these embodiments, random information is stored and is timely updated in the meta information storage unit 2200. However, random information may be updated by the external server connected to the map display device via a network. In such a case, any interface for connecting to the network and any protocol, etc. used for obtaining data are applicable. However, random information may be stored in an external recording medium whose data is readable and which can be mounted on the map display device. An example of such an external recording medium is a memory recording medium such as an HDD and an SD, an optical disc medium such as a DVD, a Blu-ray Disc, or an HD DVD. Alternatively, random information may be stored in an arbitrary external recording medium, and may be obtained from the arbitrary external recording medium. Needless to say, random information may be obtained through combination of these methods.

(10) According to these embodiments, the description is given of the TV 100 by way of example of the map display device. However, a device other than the map display device or the image display device is applicable as long as the device uses the scheme of the present invention. For example, a multipurpose electronic device, such as a video recording & playback device and a personal computer, having the function of being connected to an image display device and displaying video contents thereon is also applicable. A car navigation system provided in a car is also applicable. Needless to say, the scheme of the present invention may be implemented on other devices, such as a mobile phone or a content player.

According to the embodiments of the present invention, a remote controller for controlling an image display device is used as an input interface used by a user. However, an input interface is not limited to a remote controller as long as it uses the scheme of the present invention.

An input interface may be a remote control operation device or an interface integrated with a device implementing the scheme of the present invention.

A remote controller may be other input interface, such as a game controller, a joystick, a mouse, a trackball, a touchpad, a slide pad, a track pad, a touch panel, a stylus, a graphics tablet, a pointing stick, a NeuroPointer, and a motion sensor.

In addition, various types of mobile devices, such as a mobile phone and a PDA may have a unit included in the input interface in accordance with the scheme of the present invention.

(11) According to the map display device, part or all of the components shown in FIG. 1, etc. may be realized by a computer program or any other form. When the scheme of the present invention is realized by a computer program, the computer may read and execute the program written in a recording medium, such as a memory card or a CD-ROM, or the program may be downloaded to the personal computer through a network so as to be executed.

### INDUSTRIAL APPLICABILITY

The present invention is applicable to a device having only a remote controller as an interface and providing a map display service. Also, a device or system having the scheme of the present invention can be continually and repeatedly manufactured and sold in the manufacturing industry for business, and can be used particularly in the industry of a consumer device having a function for displaying an image and being connected to a network.

1-11. (canceled)

12. A display device comprising:
a storage unit that stores therein a map, one or more positions on the map, and one or more information pieces associated with the positions;
a map display unit operable to display the map on a display;
a focus unit operable to focus on at least one of a plurality of display area portions of a display area in which the map is displayed, in accordance with a user operation, and operable to change the focus to one of the display area portions that is adjacent to the display area portion currently in focus in a direction specified by a user operation;
a determination unit operable to determine a prescribed-sized one of the display area portions in accordance with a user operation, the prescribed-sized display area portion being a display area portion focused on by the focus unit; and
an information display unit operable to display, on the map being displayed in the prescribed-sized display area portion, an information piece associated with a position on the map being displayed in the prescribed-sized display area portion.

13. The display device of claim 12, wherein
a plurality of information pieces are associated with one or more positions included in a display area portion determined by the determination unit,
the display device further includes a switch instruction obtaining unit operable to externally obtain an instruction to switch among the plurality of information pieces, and
if the switch instruction obtaining unit obtains the switch instruction while one of the information pieces is being displayed, the information display unit switches the display to another one of the information pieces.

14. The display device of claim 13, wherein
the display area portions focused on by the focus unit are polygonal portions, into which the display area has been divided based on the map displayed by the map display unit.

15. The display device of claim 14, wherein
each polygonal portion is surrounded by roads on the map.

16. The display device of claim 12, wherein
the display area portions focused on by the focus unit are rectangular portions, into which the display area has been divided in a grid pattern.

17. The display device of claim 12, further comprising:
a route indication unit operable to indicate a route in the displayed map, wherein
the prescribed-sized display area portion is composed of a road shown by the indicated route and a portion with a prescribed width along the road.

18. The display device of claim 12, wherein
each information piece displayed by the information display unit is an advertisement for a shop located at the position.

19. The display device of claim 12, wherein
the determination unit determines a plurality of display area portions included in the display area, and
the information display unit displays information pieces associated with positions in all the plurality of determined display area portions.

20. A display method used by a display device including a storage unit that stores therein a map and an information piece associated with a position on the map, the method comprising the steps of:
displaying a map on a display;
focusing on at least one of a plurality of display area portions of a display area in which the map is displayed, in accordance with a user operation, and changing the focus to one of the display area portions that is adjacent to the display area portion currently in focus in a direction specified by a user operation;
determining a prescribed-sized one of the display area portions in accordance with a user operation, the prescribed-sized display area portion being a display area portion focused on by the focus unit; and
displaying, on a map being displayed in the prescribed-sized display area portion, an information piece associated with a position on the map being displayed in the prescribed-sized display area portion.
